(19) United States
(12) Patent Application Publication
(10) Pub. No.: US 2025/0069012 A1
(43) Pub. Date: Feb. 27, 2025

(54) SURFACING OPPORTUNITIES TO PREVENT PREDICTED ATTRITION OF USERS OF ACCESS MANAGEMENT SYSTEMS

(71) Applicant: Pax8, Inc., Greenwood Village, CO (US)

(72) Inventors: Sam Rachmil-Etter, Greenwood Village, CO (US); Scott Bates, Aurora, CO (US)

(21) Appl. No.: 18/236,633

(22) Filed: Aug. 22, 2023

(51) Int. Cl. G06Q 10/0635; G06N 7/00; G06N 20/00; G06Q 30/0202

(52) U.S. Cl. CPC G06Q 10/0635; G06N 7/00; G06N 20/00; G06Q 30/0202

(57) ABSTRACT

A system and method for predicting third-party software licensee attrition and/or MSP organization client/customer attrition by a predictive model is shown. A user interface is provided for users to communicate with access management system. In particular, data and information from the access management system can be provided to the predictive model for training, and the predictive model predicts the third-party software licensee attrition and/or MSP organization client/customer attrition of managed service providers. The predictive model in the access management system further provides recommendations to the managed service providers by the user interface.

### TECHNICAL FIELD

Embodiments described herein relate to access management systems for third-party software tools and, in particular, to systems and methods for surfacing opportunities to prevent predicted attrition of users of access management systems.

### BACKGROUND

Many organizations, especially small and medium-sized businesses, engage a managed service provider (MSP) to administer, support, and provide access (e.g., via license resale) to third-party software tools provided by one or more third-party software vendors to simplify the organizations' business operations.

However, as an intermediary, MSP are often undeserving targets of blame for third-party software defects, software vendor support gaps or latency, and the like. In circumstances in which users of software tools licensed by an organizations are not satisfied with those products, or are not satisfied with the administration and the support from the MSP or software vendors, the organizations may discontinue or not renew engagements with the MSP and/or discontinue or not renew licensing of one or more third-party software tools.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system for providing access management as a service, such as described herein.

FIG. 2 depicts a system diagram of a system configured to provide access management as a service for predicting third-party software licensee attrition and/or MSP organization client/customer attrition, such as described herein.

FIG. 3 depicts an alternative system diagram of a system configured to provide access management as a service for predicting third-party software licensee attrition and/or MSP organization client/customer attrition, such as described herein.

FIG. 4 depicts a diagram depicting a flowchart of training a predictive model to predict third-party software licensee attrition and/or MSP organization client/customer attrition, such as described herein.

FIG. 5 depicts a diagram depicting a flowchart of phase I in a predictive model to identify attributes affecting third-party software licensee attrition and/or MSP organization client/customer attrition, such as described herein.

FIGS. 6-8 depict a table of identified attributes which affect third-party software licensee attrition and/or MSP organization client/customer attrition, such as described herein.

FIG. 9 depicts a diagram of identified attributes affecting third-party software licensee attrition and/or MSP organization client/customer attrition of MSPs in the phase I of a predictive model, such as described herein.

FIG. 10 depicts a diagram depicting a flowchart of phase II in a predictive model, such as described herein.

FIG. 11 depicts a diagram depicting a flowchart of phase III in a predictive model to generate one or more output data from the prediction model, such as described herein.

FIGS. 12 and 13 depict a user of the MSP executing an instance of the MSP application rendering a graphical user interface of an access management system, such as described herein

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to computing systems, computer architectures, and computer-implemented methods configured to provide, control, and manage access to third-party software tools. In particular, embodiments described herein relate to systems and methods for predicting third-party software licensee attrition and/or MSP organization client/customer attrition by the access management system.

More specifically, a system described herein communicates with third-party software vendors either by accessing third-party software vendor application programming interface (API) endpoints and/or by providing an interface for communication with third-party software vendors and MSPs to predict third-party software licensee attrition and/or MSP organization client/customer attrition by a predictive model. Such a system may be used to surface alerts and suggestions to inform MSPs that an organizational client of theirs is likely to be satisfied or dissatisfied.

More simply, a multi-MSP, multi-organization system as described herein can leverage data (e.g., support log data) to which it has access in order to predict whether a particular organization is likely to change its engagement with an MSP either by adjusting currently-licensed software or discontinuing engagement with the MSP altogether.

For example, a machine learning model, generative artificial intelligence, neural net, deep neural net or other suitable artificial intelligence or trainable set of parameters (herein, simply “predictor” or “predictive model”) may be trained on a training dataset assembled from historical log data, support desk data, support ticket data (e.g., duration, number of tickets, and so on), business attribute data (e.g., verticals, size, geography, customer profile/demographics, and so on), MSP attribute data (e.g., size, typically serviced verticals, and so on), engagement/license data or attributes, and other data. In these examples, the predictive model may be trained to output a set of activations (e.g., a decimal or float value from 0.0 to 1.0) each in respect of a one output label of a set of output labels which can be, as an example, engagement status of an organization as of different times, events, or the like. For example, engagement statuses may include or correspond to: change in MSP revenue (positive or negative) attributable to an organization month-over-month, quarter-over-quarter, and so on; change in seats for particular licenses over different time periods; termination with MSP; engagement with a new MSP; and so on. In some cases, output labels for past events or time periods may be forward-looking and based on an eventual true status, such as: organization will disengage with MSP in three months; engagement will not change this quarter; and the like. In some cases, forward-looking labels can include and or maybe based on license statues as well, such as without limitation: organization will reduce license seats by 10% in upcoming quarter; organization will change from Product A to Product B; organization will receive promotional rate for 30 days; a promotional rate will expire in 60 days; and so on. These foregoing example labels, both forward-looking and otherwise are merely examples and are not intended to be limiting.

Once trained against training data as described above to output activations corresponding to labels associated with different engagement statuses for a particular organization engaged with a particular MSP, a predictive model as described herein can be provided with real-time data in respect of a particular organization or particular MSP. In response, activations output by the predictive model may serve as a prediction of an organization's future engagement status with its MSP(s). In many constructions, output of the predictive model may be referred to as an “attrition risk assessment.” and may take the form of a numerical value that serves as a proxy for a probability that a particular organization will, as of some event or time, disengage with the MSP.

For example, the predictive model may consume real-time data from an organization and provide, as output, a high activation associated with a label of “organization will reduce seats of Product A by 50% in the upcoming quarter” or a high activation associated with a label of “organization will disengage with MSP before next billing cycle.” In response to these predictions (which may take the form of numerical attrition risk assessment values), a system as described herein can be configured to surface alerts to the MSP so that the MSP may take action to prevent the prediction action(s).

For example, in some cases, an access management system as described herein can include a backend application configured to communicate with a frontend application. The frontend application can be a web application or a native application instantiated over local processing and memory resources of an MSP's client device, such as a laptop or desktop computing application. The frontend can render a graphical user interface to receive input from and provide information to an agent of the MSP, including information about each of the MSP's organizational clients. Alerts as described herein can be surfaced with this graphical user interface, warning the MSP of a predicted upcoming customer attrition.

In further embodiments, each of the labels associated with a trained predictive model as described herein can be tagged with one or more attributes. Example attribute tags may include a classification such as a positive forward-looking result (e.g., revenue increases over the next four quarters) or a negative forward-looking result (e.g., organization will disengage with MSP in 90 days). In these examples, alerts can be surfaced to an MSP via the graphical user interface of the frontend based on the classification. More specifically, in some configurations, only negatively-classified predictions (e.g., negative attrition risk assessment values) may be surfaced to an MSP. In other cases, other classifications of predictions may be surfaced.

In some cases, positively-classified predictions can be leveraged to assist an MSP with revenue forecasting in upcoming time periods, which may assist the MSP with hiring or expansion budgeting decisions.

In many embodiments, the predictive model may be configured to identify features or attributes of training data that have the strongest influence in respect of a particular prediction. In these examples, the identified features may be surfaced to an MSP so as to provide useful contextualization of one or more predictions. For example, an MSP may receive via a graphical user interface of a frontend application of an access management system as described herein an alert that “ORGANIZATION A has experienced high trouble ticket wait times over the past quarter and is predicted to disengage in 90 days.”

In this example, high trouble ticket volume and/or wait times may be identified by the predictive model as an influential factor in the prediction that the organization is likely to disengage within 90 days. As another example, an MSP may receive via a graphical user interface of a frontend application of an access management system as described herein an alert that “ORGANIZATION A, within VERTICAL 1 is currently using SOFTWARE XYZ instead of SOFTWARE ABC, and is predicted to disengage in 90 days.” In this example, use of one software package over another may be a predictor, within a particular vertical, of disengagement.

In still further embodiments, a predictive model as described herein can be configured to activate against labels associated with interventions taken by MSPs in response to negatively-classified predictions. For example, if an MSP receives a negatively-classified prediction and takes an intervention that prevents the predicted result, the intervention may be added as a forward-looking label itself, after which the predictive model may be retrained. In these constructions, a system as described herein may be configurable to offer intervention suggestions to MSPs that receive negatively-classified predictions.

More simply, as one example, an MSP may receive via a graphical user interface of a frontend application of an access management system as described herein an alert that “ORGANIZATION A is predicted to disengage in 90 days; recommend permanent or temporary license fee reduction as intervention.” In another example, an MSP may receive via a graphical user interface of a frontend application of an access management system as described herein an alert that “ORGANIZATION A is predicted to disengage in 90 days; recommend change from SOFTWARE ABC to SOFTWARE DEF.”

These foregoing examples are not limiting of the embodiments described herein. Generally and broadly, data in respect of an access management system may be leveraged to generate training data, to generating forward-looking label sets representing engagement status(es) and/or license status(es), and to use such training data and label sets to train a machine learning model (e.g., a neural net) that, in turn, can be used to assign labels to real-time data of current organizational clients of MSPs leveraging the same access management system. In this manner, rich actionable notifications can be surfaced to MSPs and their agents that in turn can assist with budgeting, planning, and/or business development. In many cases, such notifications can assist MSPs with client retention, suggesting interventions and/or intervention timing that can prevent client attrition.

An access management system can be implemented in a number of suitable ways. For example, in some cases, an access management system can provide access (e.g., license resale) to third-party software tools by communicating with third-party software vendor API endpoints, each in a manner dictated by the third-party software vendor. More simply, in these constructions, an access management system serves as a wrapper (and maintainer thereof) for APIs of different software vendors to automate license and billing management operations in respect of those software platforms. Such systems can be referred to as “vendor-specific API” implementations of an access management system.

In other cases, an access management system can define and leverage a bidirectional standard interface and protocol for arbitrary third-party software vendors (also referred to herein as “software vendors”) and MSPs to communicate with and exchange information with a centralized access management system. More simply in these constructions, an access management system defines an API and/or data exchange format with which vendors can comply to feed license and billing management data into an access management system as described herein. Such systems can be referred to as “vendor-agnostic” implementations of an access management system.

Independent of configuration, an access management system as described herein is understood as a system configured to communicably couple to one or more third-party software vendor systems to obtain usage data, license information, and other data and metadata generated in respect of use of software tools provided by that third party. Such information can be used, as described above, to generate training data and forward-looking status labels from historical data so as to train a machine learning model, such as described above.

For simplicity of description, the embodiments described herein are described in respect of a vendor-agnostic implementation of an access management system. It may be appreciated that this is merely one example, and organizational data and software usage data can be collected and stored in number of different suitable ways. More specifically, embodiments described herein reference an access management system hosting a bidirectional standard interface that can be used to exchange information with software vendors. This information can be thereafter aggregated, used, and/or otherwise presented to agents of an MSP such as described above.

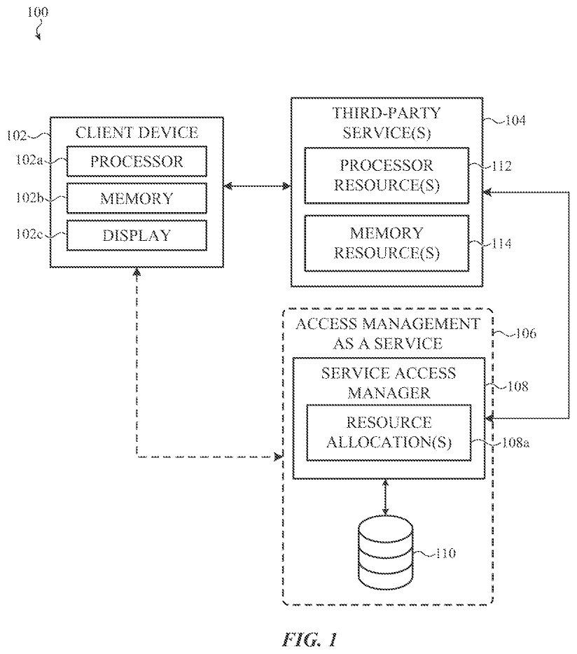

FIG. 1 depicts a system 100 for providing access management as a service, such as described herein. The system 100 can include, in a simplified architecture, and/or be defined by communications by and between, a client device 102, a third-party service 104, and an access management service 106.

The client device 102 can be any suitable electronic device. Examples include, but are not limited to, cellular phones, laptop computers, desktop computers, server computers, and so on. More generally, the client device 102 may be any electronic device or computing resource configured to communicably intercouple (e.g., via one or more networks) to one or more other electronic devices, such as a server computer instantiating an instance of a third-party service 104 or a server computer executing an instance of the access management service 106.

In some cases, the access management service 106 can be operated to request or assign or sublicense licenses to use the third-party service 104 on behalf of a user of the client device 102. For example, the access management service 106 can be configured to leverage an API of the third-party service 104 to automatically request one or more licenses to access the third-party service 104. In some examples, the access management service 106 can store information about the request for licenses in a database and the access management service 106 can provide the information to a predictive model for training.

In other cases, the access management service 106 can be operated to revoke and/or terminate licenses. For example, the access management service 106 can be configured to receive a request from the third-party service 104 and/or the client device 102 (or an organization admin associated with the client device 102 and/or a user of the client device 102) to terminate a previously-granted license. In some examples, the access management service 106 can store information about the revocation and termination of the licenses in a database and the access management service 106 can provide the information to a predictive model for training.

In some cases, the access management service 106 can be operated to request provisioning of licenses to access the third-party service 104 on behalf of a user of the client device 102. The access management service 106 can store the information of the provisioning of the licenses in a database 110. For example, the access management service 106 can be configured to leverage an API of the third-party service 104 to automatically request provisioning/issuance of one or more licenses to access the third-party service 104.

The access management service 106 can store the information including the provisioning and issuance of one or more licenses to access the third-party service 104 in the database 110 for the training purposes in a predictive model. As discussed herein, provisioning and/or usage of a license may include the issuance of a new license, alterations to an existing license, and/or cancellation of an existing license. In some examples, the access management service 106 can provide the information herein to a predictive model for training.

In many constructions the access management service 106 and the third-party service 104 are each implemented as instances of software executing over one or more virtual or physical resources associated with a cloud-based infrastructure, such as may be provided by a cloud services provider. In these embodiments, processing resources associated with, and/or allocated to, a particular server instance can cooperate with memory resources associated with the server instance to execute one or more computer readable instructions to instantiate an instance of software defining and/or implementing the third-party service 104 or the access management service 106.

More generally, although it may be appreciated that the third-party service 104 and the access management service 106 may be implemented in any number of ways and may be configured to communicate over a variety of protocols, in many embodiments each is implemented as a separate instance of cloud-based software supported by separate infrastructure.

It may be appreciated that the third-party service 104 can serve as a host of any suitable software product. Examples include, but are not limited to, email services, messaging services, instant messaging services, documentation services, office product services, word processing services, securing services, database services, design services, translation services, music and/or video production services, information technology infrastructure management services, training models, and so on. These examples are not exhaustive.

As noted above, an access management service such as the access management service 106 can be configured to request and revoke software licenses to particular software products, such as to the third-party service 104.

In addition, the access management service 106 can be configured to facilitate access to one or more functionalities of one or more third-party APIs (such as API endpoints provided by the third-party service 104). For example, the access management service 106 can be configured to access a license usage statistics API endpoint of a particular third-party API of the third-party service 104, or, in some embodiments, provide an interface by which the third-party service 104 can report license usage data to the access management service (e.g., provide an API endpoint at which the third-party service 104 can report license usage data). As discussed herein, the license usage data can be, in part, to generate training data used as input to extend or supplement a training dataset that in turn can be leveraged to train a predictive model to predict a behavior of the user of the client device 102, and attrition risk exposure of an MSP.

More particularly, the access management service 106 can include a service access manager 108 in communication with a database 110 storing information regarding license usage, license information, license provisioning and/or use information, tickets, and error messages from the client device 102. As a result of this construction, the service access manager 108 can be configured to access the database 110 to further provide the information stored in the database 110 as input to train the predictive model.

In some examples, the access management service 106 and/or the service access manager 108 can be leveraged by the MSP to generate invoices based on the use of the third-party service 104 by a user of the client device 102. In other cases, the access management service 106 and/or the service access manager 108 can be leveraged by an MSP to generate invoices based on the use of the third-party service 104 by an organization associated with the client device 102. In other cases, the access management service 106 can be used by an MSP to support an organization's third-party licensing needs, such as described above.

In some examples, the service access manager 108 can be operated to obtain usage data from one or more third-party services, such as the third-party service 104, and to apply a new business rule to those usage data to determine an effect (if any) on invoices generated from those data. For example, a particular MSP may desire to understand the effect of issuing a coupon code for one of its client organizations.

In such an example, the service access manager 108 can be operated to create a set of jobs, each including at least one respective serverless function, which can be executed to obtain real-time usage data for the client organizations from a given time period, such as the last quarter or the last month. With this real-time, accurate, production data obtained from the third-party service 104, the service access manager 108 can apply the new business rule to change pricing according to the coupon code, informing the MSP of the effect of issuing such a code to the client.

In some examples, service access manager 108 can be configured to determine calculations for the MSP for any suitable number of scenarios involving the proposed coupon code and the proposed coupon code can be suggested by a predictive model after the predictive model is trained by the stored information in the database 110.

For example, the API access manager 108 can be configured to provide output simulating/project effects of applying the coupon code to one product, multiple products, one user, multiple users, one day, one week, one month, and so on. In some examples, the API access manager 108 can be configured to simulate effects of the coupon code (or more generally any new business rule) over different times of a given billing year; for example the client organization may exhibit different usage data during different quarters of the year, and thus enabling a coupon code for different times of the year may result in different effects to MSPs revenue.

In some examples, the access management service 160 can be used to communicate with the MSP and provide third-party software licensee attrition and/or MSP organization client/customer attrition of the use of the third-party service 104 by the users of the client device 102. In other cases, the access management service 160 can be used to provide predictions and recommendations regarding the behavior of the users of the client device 102. The prediction may include the revenue that the MSP may generate from the client device 102. The prediction may include the risk that the client device 102 may discontinue the service with MSPs. The behavior of the users of the client device 102 may include that the users of the client device 102 decide to switch from a software of a first third-party service 104 to another software of a second third-party service 104.

As noted above, an organization may engage an MSP and/or a value-added reseller (VAR) to license access to, and/or actively administer, one or more third-party software tools, which may be referred to herein as “collaboration tools.” Example collaboration tools include email services, telephony services, instant messaging systems, documentation systems, word processing systems, information technology management systems, ticketing systems, issue tracking systems, incident response systems, software repositories, design platforms, video and/or audio production platforms, networking platforms, identity management systems, and so on. A person skilled in the art may appreciate that these example collaboration tools are not exhaustive of all types of software tools that may be licensed by an organization for use by one or more employees; an organization may license access to collaboration tools developed and maintained by different third-party software vendors (herein, software “vendors”).

As an organization's collaboration tool library (and/or employee headcount) grows, licensing costs likewise increase as does the importance of active license management. Phrased another way, organizations and MSPs/VARs may often be tasked with regular auditing whether licenses are actively being used to identify unused licenses that can be terminated. The access management service 106 may streamline these tasks, ensuring that the correct number of licenses for an organization are maintained over time. The access management service 106 may store this information in the database 110 and this information can be used as input for the predictive model.

As discussed above, it may be desirable for the access management service 106 to have a standardized interface for communicating with the third-party services 104. This may include a standard format for requests to provision a license, as well as a number of API endpoints provided by the access management service 106 to receive license provisioning and/or use information, or, more generally, license information, from the third-party services 104 in a standardized manner.

The access management service 106 may provide requests for provisioning and/or usage of a license (e.g., creation of a new license, alteration of an existing license, cancellation of an existing license, or the like) to the third-party service 104. Subsequently, the access management service 106 may receive license provisioning and/or use information about the request for provisioning the license from the third-party service 104 at a license provisioning and/or use information API endpoint provided by the access management service 106. Further, the access management service 106 may receive license information about the license via one or more license information API endpoints from the third-party system 104.

The access management system 106 may store the license provisioning and/or use information and/or license information in a database for later use. In some cases, the access management system 106 may combine the license provisioning and/or use information and/or license information with other information, such as that obtained from operating access management as a service, to create a robust dataset including a state of a number of licenses managed by the access management system 106.

For example, the access management system 106 may combine the license provisioning and/or use information and/or the license information with information about an MSP managing the license on behalf of a licensee (i.e., customer), information about the licensee, information about the third-party providing the third-party software tool, or any other information. The access management system 106 may process or otherwise alter the license provisioning and/or use information and/or the license information to generate reports, invoices, or other informational content. The access management service 106 may store this information in the database 110, and the access management service 106 may provide this information as input to train a predictive model. The access management service 106 may receive information from the predictive model and provide those to MSPs.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, the access management service 106 may use any suitable architecture for communicating with the third-party service 104. In some embodiments, a backend application instance may be configured to host an API or set of APIs that third-party vendors communicate with in order to relay information relating to the licensing and/or usage of third-party software tools. In yet other examples, a monolithic, microservice, or hybrid architecture may be used. In short, the access management service 106 may provide the functionality described above in any suitable manner, and have any suitable system architecture.

Further, it may be appreciated that the client device 102 can be configured in any number of suitable ways. In one embodiment, the client device 102 is an electronic device that includes a processor 102a, a memory 102b, and a display 102c. The processor 102a and the memory 102b cooperate to instantiate an instance of software that can be configured to communicate with and/or exchange information with the service access manager 108 and/or the third-party service 104. In some examples, the instance of software may be referred to as a client application and/or frontend that corresponds to a backend instance operated at the third-party service 104 and/or the service access manager 108.

Similarly, the service access manager 108 may be one or more instances of software executing over one or more resource allocations 108a. The resource allocations 108a may be physical or virtual, and may be associated, for example, with a cloud-based infrastructure, such as may be provided by a cloud services provider. The resource allocations 108a may include processing resources cooperating with memory resources to execute one or more computer readable instructions to instantiate one more instances of software defining and/or implementing the service access manager 108.

The third-party service 104 may similarly be one or more instances of software executing over one or more processor resources 112 in connection with one or more memory resources 114. The processor resources 112 and the memory resources 114 may be physical or virtual, and may be associated, for example, with a cloud-based infrastructure, such as may be provided by a cloud services provider. Generally, the processor resources 112 and the memory resources 114 of the third-party service 104 are different from the resource allocations 108a of the service access manager 108, as the third-party service 104 and the service access manager 108 are different instances of software supported by separate infrastructure. The processor resources 112 may execute one or more computer readable instructions from the memory resources 114 to instantiate one or more instances of software defining and/or implementing the third-party service 104.

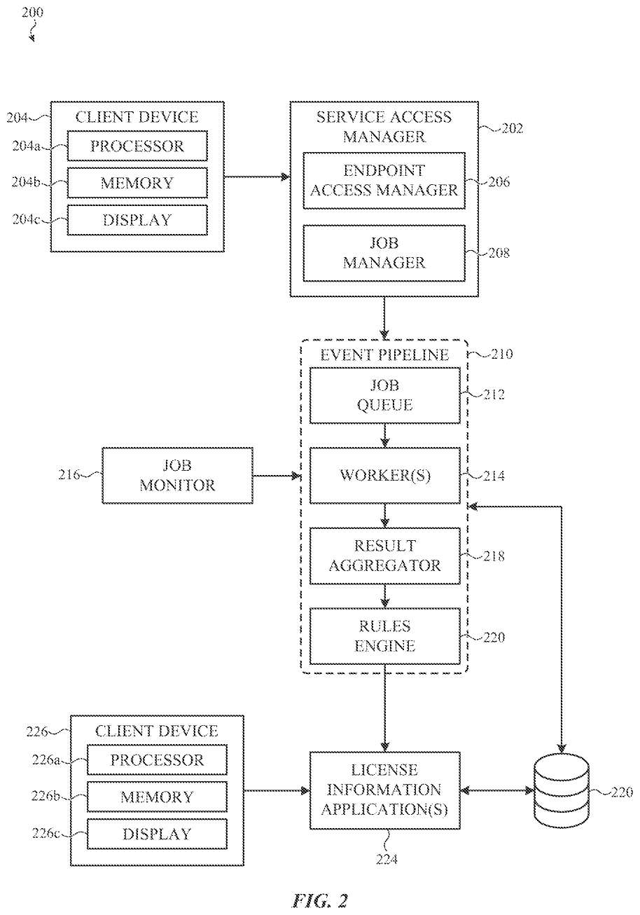

FIG. 2 depicts a system diagram of a system 200 configured to provide access management as a service, such as described herein.

As with other embodiments described herein, the system 200 includes a service access manager 202 which may be configured to receive command and control instructions from a device operated by an agent of an MSP, such as a client device 204. The agent operating the client device 204 can issue instructions to the service access manager 202 on behalf of an organizational client of the MSP to provision one or more licenses to one or more third-party software tools, cancel one or more existing licenses to one or more third-party software tools, or obtain usage information about one or more third-party software tools, among other operations.

The service access manager 202 can be additionally configured to retrieve and access usage data in respect of existing and/or already-provisioned licenses. For example, for vendor-specific implementations, the service access manager 202 may on a daily or monthly basis execute (or cause to be executed) one or more API requests to obtain usage data so as to generate multivendor unified invoices for each organizational client of the MSP. For vendor-agnostic implementations the service access manager 202 can be configured to request updated data via a bidirectional standard interface or may await publication of such usage data by one or more vendors. As with other examples, this usage data can be used to generate multivendor unified invoices for each organizational client of the MSP. Specifically, usage data for a particular organizational client of an MSP can be obtained for each software vendor whose software is licensed by the organizational. This usage data, of each seat of each software license of each software platform can be used to calculate costs in arrears according to a relevant license agreement between the MSP and the software vendor and/or the MSP and the organizational client. These arrears calculations, for the organization's use of each software product for a given time period (e.g., month) can be merged into a single invoice for the MSP to forward to the organization.

In addition, as noted above, the data collected by and/or generated by operation of the service access manager 202 can be used to generate training data and/or forward-looking status labels from historical usage data of multiple organizations and MSPs in order to train a predictive model to predict third-party software licensee attrition and/or MSP organization client/customer attrition of the MSP.

For example, a forward-looking status label, based on historical usage data, may be generated by determining or identifying occurrence of an event within historical usage data, labeling data that precedes this identified event with a label identifying the event as occurring in the future. For example, a system as described herein can be configured to identify from log and/or usage data that an organization changed MSPs in December of a given year. For this same year, usage data from November can be tagged and/or labeled with “Organization will change MSPs in 1 mo.” Similarly, for this same year, usage data from October can be tagged and/or labeled with “Organization will change MSPs in 2 mo” and so on.

In this manner, data from October and November is tagged with a true, forward-looking label that captures an eventual factual status describing a relationship between the MSP and the organization. This forward-looking tagged data can be used as, or can be used to generate, training data for a neural network such that signals within current, real-time organizational usage data (that may not be readily apparent to an MSP or other human reviewer) can be provided as input to the trained neural network which may provide an output label offering a prediction such as “Organization will change MSPs in 1 mo” or similar.

As noted above, such predictions can be surfaced to an agent of the MSP, for example within a graphical user interface of the client device 204.

As may be appreciated by a person of skill in the art, recommendations can be framed in a number of ways. In many cases, it may be useful to present recommendations to an MSP in terms of incremental effects—positive, neutral, or negative—to revenue of the MSP. It may be appreciated, however that a recommendation or surfaced notification or prediction as described herein can be presented in a number of different suitable contexts.

In many cases, the client device 204 can be an electronic device such as the client device 102 of FIG. 1; the client device 204 can include a processor 204a, a memory 204b, and/or a display 204c that are configured to instantiate an instance of software configured to receive command and control instructions from a user of the client device 204. More simply, the client device 204 can be configured in a similar manner as the client device 102 of FIG. 1, and thus any additional description thereof is not repeated.

Upon receiving an instruction from the client device 204, and/or in response to the occurrence of a scheduled event, the service access manager 202 can be configured to access one or more functions from an endpoint access manager 206. Each retrieved function can thereafter be wrapped, with appropriate arguments, into a job by a job manager 208.

Each job created by the job manager 208 can be added as input to an event pipeline 210, which can include a job queue 212. Job items or work items can be added to and removed from the job queue 212 in any suitable order. One or more worker nodes 214 can be configured to pop jobs from the job queue 212 to execute those jobs/work items against respective third-party APIs. In this manner individual functions, configured with suitable functions, can be executed in series and/or asynchronously.

Once a job successfully executes, the results of the execution can be passed to and/or otherwise received by a result aggregator 216. The result aggregator 216 can, in turn, bundle results of execution of one or more jobs as a single structured data object and can provide that structured data object to a rules engine 218, which may apply one or more rules to the structured data (e.g., as data transforms), based on the MSP initiating the job and/or the organization on behalf of which the MSP is acting.

The results of the execution may be license provisioning and/or use information, which is information related to the provisioning and/or usage of a license to a third-party software tool, or, more generally, license information, which is any information related to a license to a third-party software tool. The results can be stored in the database 220, and the results can be used as input to extend or supplement a training dataset that in turn can be leveraged to train a predictive model to predict third-party software licensee attrition and/or MSP organization client/customer attrition of the MSP, such as described above.

An MSP may interact with the service access manager 202 via the client device 204 to obtain licenses for third-party software tools on behalf of an organization, cancel licenses for third-party software tools on behalf of an organization, or obtain usage data about third-party software tools on behalf of an organization. The event pipeline represents one exemplary way of performing the various tasks that may be performed by the service access manager 202; those skilled in the art will appreciate that the same functionality may be performed using any number of different architectures, all of which are contemplated herein. The events in the event pipeline here can be stored in the database 220, and the events in the event pipeline can be used as input to extend or supplement a training dataset that in turn can be leveraged to train a predictive model to predict third-party software licensee attrition and/or MSP organization client/customer attrition of the MSP.

The license provisioning and/or use information and/or license information may be stored in a database 220 for later use. For example, information about the status of a provisioned license, information about the usage of a license, or any other information related to a license may be stored in the database 220.

A job monitor 222 may be configured to monitor execution of each job by each worker node 214 to determine whether the worker nodes 214 execute the jobs successfully. In an event that the job monitor 222 determines that a particular job has failed, the job monitor 222 may restart the job, generate a notification indicating that the job has failed, or take other action. In some examples, the job monitor 222 may monitor the jobs in the event pipeline 210 so the results and the rules may stored as training data and/or otherwise appended to a training dataset.

License provisioning and/or use information and/or license information may be used by one or more license information applications 224 to provide one or more functions related to the information. An additional client device 226 may communicate with the license information applications 224 to view or otherwise interact with information related to a license or licenses. The additional client device 226 may be an electronic device including a processor 226a, a memory 226b, and/or a display 226c that are configured to cooperate to instantiate an instance of software configured to display a graphical user interface for interacting with information related to one or more licenses for third-party software tools.

For example, an invoicing license information application 224 may aggregate information (i.e., by querying the database 220) to generate an invoice for a customer of an MSP related to the use of one or more third-party software tools. As another example, a usage license information application 224 may aggregate information to generate a usage report for a customer of an MSP related to one or more third-party software tools.

In general, the license information application 224 may display, manipulate, process, or otherwise interact with license provisioning and/or use information and/or license information to provide any number of functions. In some examples, the usage license information application 224 may provide the information to the predictive model for training and the predictive model may predict the attrition risk exposure of MSPs when the users of the client device 204 or the client device 226 use MSPs.

These foregoing embodiments depicted in FIGS. 1-2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

In the system 200 discussed in FIG. 2, custom functions are used to communicate with each third-party API endpoint. As discussed above, each of these custom functions must be created and maintained. Considering that the service access manager 202 may support thousands or more software vendors, each having several API endpoints that need to be accessed to provision and otherwise manage licenses, the number of custom functions required quickly becomes burdensome. Further, third-parties may change their API, necessitating updating of existing custom functions or the creation of new custom functions for interfacing therewith.

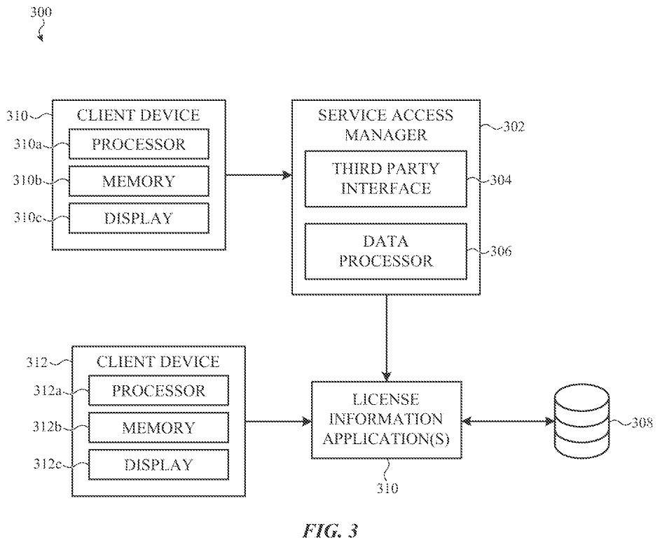

FIG. 3 depicts an alternative architecture for a system 300 in which a service access manager 302 includes a third-party interface 304 and a data processor 306.

Similar to that described above, the service access manager 302 may receive command and control instructions from a device operated by an MSP, such as a client device 310. The MSP operating the client device 310 can issue instructions to the service access manager 302 on behalf of an organizational client of the MSP to provision one or more licenses for the organization to one or more third-party software tools, cancel one or more existing licenses to one or more third-party software tools, or obtain usage information about one or more third-party software tools, among other things.

For simplicity of description, the following embodiments reference usage data retrieval instructions received from the client device 310, automatically transmitted to the service access manager 302 from the client device or another service or system, and/or scheduled usage data queries or other actions of the service access manager 302.

In many cases, the client device 310 can be an electronic device including a processor 310a, a memory 310b, and/or a display 310c, which operate as described above. The service access manager 302 may store results of executing one or more usage data retrieval instructions to a database 308, and the service access manager 302 may provide the retrieved usage data (which may be tagged with forward-looking labels, current state labels, and/or otherwise organized as described herein) to a predictive model training dataset for subsequent training of a predictive model, such as described above. In some embodiments, a trained predictive model may predict the attrition risk exposure of the MSP when the users of the client device 310 use the client device 310 connecting to the MSP.

More generally, in response to an action taken by the client device 310, and/or in response to the occurrence of a scheduled event, the service access manager 302 can be configured to communicate with a third-party service (e.g., via a third-party API) to provision licenses, cancel licenses, or obtain usage information—all of which may be added to a training dataset with appropriate status labels for predictive training as described above. The third-party interface 304 may be responsible for initiating communication with the third-party service (e.g., by formulating a request corresponding to an API standard of the third-party service). In some embodiments, the third-party interface 304 may also provide an interface by which third-party services can communicate with the service access manager 302. For example, the third-party interface 304 may provide one or more API endpoints at which third-party services can report usage information about one or more third-party software tools, among other information, to the service access manager 302. In one specific example, the third-party interface 304 may initiate communication with a third-party service in order to provision one or more licenses of one or more third-party software tools.

As part of the request to provision these licenses, information about how to access a license provisioning and/or use information API endpoint may be provided. In some embodiments, however, the information about how to access the license provisioning and/or use information API may be provided outside of the initial request for provisioning one or more licenses. In some examples, the third-party interface 304 may store the communication data in the database 308. The service access manager 302 may send the communication data to a predictive model for training, and the predictive model may analyze the communication data and predict third-party software licensee attrition and/or MSP organization client/customer attrition of MSPs.

The license provisioning and/or use information API endpoint may be configured to receive license provisioning and/or use information about the one or more licenses, which is information related to the provisioning of the one or more licenses. For example, the license provisioning and/or use information may include a status of provisioning of the one or more licenses (e.g., “in-progress,” “succeeded,”, “failed.” etc.), system logs of a third-party system performing the provisioning of the one or more licenses, or any other information relevant to the provisioning of the one or more licenses. The license provisioning and/or use information may stored as training data and/or otherwise appended to a training dataset. The predictive model, once trained on data as described above, can be leveraged to—among other use cases—predict attrition risk of specific organization clients of an MSP by providing to that trained predictive mode, current status of the provisioning of the one or more licenses, trouble ticket logs of the third-party system, usage data of one or more third party systems, and so on.

The service access manager 302 may process the license provisioning and/or use information at the data processor 306. For example, the data processor 306 may combine the license provisioning and/or use information with other information obtained in the course of providing access management as a service, such as information about the MSP managing the license associated with the license provisioning and/or use information, information about the licensee for the license associated with the license provisioning and/or use information, previously obtained information about the license associated with the license provisioning and/or use information, information about a software vendor of the third-party software tool of the license associated with the license provisioning and/or use information, or any other information collected or generated in the course of providing access management as a service.

The combined information from the data processor 306 may be referred to as enriched license provisioning and/or use information, and may be stored in a database 308 for later use. In some examples, the data processor 306 may be used to train the predictive model based on the license provisioning and/or use information with other information obtained in the course of providing access management as a service. For example, if the information about the licensee for the license associate with the license provisioning and/or use information shows that the licensee is not satisfied with the software, the predictive model may be trained with this information and predict any licensee similar to the licensee in the history may not be satisfied with the software, either.

More generally, the third-party interface 304 may provide one or more license information API endpoints at which a third-party system can provide any information related to a license to a third-party software tool managed by the access management system. The license information may not be related to the provisioning and/or usage of a license, but rather may be related to the license in any manner.

Examples of license information include usage information associated with a particular license (i.e., whether a license is currently being used or not), pricing information associated with a license, or any other information related to the license. In some examples, usage information associated with a particular license (i.e., whether a license is currently being used or not), pricing information associated with a license, or any other information related to the license may be used in a predictive model for training, and the predictive model may predict the attrition risk exposure of MSPs when the users of the client device 310 or the client device 312 use MSPs.

Similar to the license provisioning and/or use information, on receipt of license information from a third-party service, the service access manager 302 may process the license information at the data processor 306. For example, the data processor 306 may combine the license information with other information obtained in the course of providing access management as a service, such as information about the MSP managing the license associated with the license information, information about the licensee for the license associated with the license information, previously obtained information about the license associated with the license information, information about a software vendor of the third-party software tool of the license associated with the license information, or any other information collected or generated in the course of providing access management as a service.

The combined information from the data processor 306 may be referred to as enriched license information, and may be stored in the database 308 for later use. In addition, the service access manager 302 may send the combined information to a predictive model, and the predictive model may use the combined information to predict the may predict the attrition risk exposure of the MSP.

License provisioning and/or use information and/or license information may be used by one or more license information applications 310 to provide one or more functions related to the information. An additional client device 312 may communicate with the license information applications to view or otherwise interact with the license provisioning and/or use information and/or license information. The additional client device 312 may be an electronic device including a processor 312a, a memory 312b, and/or a display 312c that are configured to cooperate to instantiate an instance of software configured to display a graphical user interface for interacting with the license provisioning and/or use information and/or license information. For example, an invoicing license information application 310 may aggregate information (i.e., by querying the database 308) to generate an invoice for a customer of the MSP related to the use of one or more third-party software tools.

As another example, a usage license information application 310 may aggregate information to generate a usage report for a customer of an MSP related to one or more third-party software tools. In general, a license information application 310 may display, manipulate, process, or otherwise interact with license provisioning and/or use information and/or license information to provide any number of functions. In some examples, the usage license information application 310 may provide the information to the predictive model for training and the predictive model may predict the attrition risk exposure of MSPs when the users of the client device 310 or the client device 312 use MSPs.

These foregoing embodiments depicted in FIGS. 1-3 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in some cases, an MSP may be provided with multi-client attrition risk assessments. For example, if multiple organizations within the same vertical are all predicted to disengage with the MSP, an attrition risk assessment associated with that vertical may be provided in a graphical user interface as described herein. In other cases, an attrition risk assessment may be provided in respect of a particular size of organization, a particular combination of attributes (e.g., small business within a particular vertical), a particular geography, a particular software product, a particular software product vendor, a particular software product type, and so on. In these examples, an attrition risk assessment may be presented as a annual recurring revenue risk assessment (e.g., ARR risk assessment) metric.

Generally and broadly, a person of skill in the art may readily appreciate that attrition risk assessments can be provided in different contexts and may be presented and/or surfaced in a user interface in a number of suitable ways. In many cases, attrition risk assessments can inform an MSP of attrition risk due to use of or engagement with a particular software vendor, a particular support protocol or method, a particular ticketing system, a particular service agent of the MSP, a particular salesperson/business manager of the MSP, a particular promotion schedule or promotion type offered by the MSP, a particular vertical serviced by the MSP and so on. These surfaced risk assessments can provide valuable insight to an MSP to intervene and address organizations' concerns before disengagement.

For example, an MSP may receive an attrition risk assessment value in respect of an organization of a particular size within a particular vertical using a particular software. For example, a dentists office employing ten employees that use a particular patient invoicing system. It may not be readily apparent to the MSP that small dental practices benefit significantly from a relatively minor feature of a different patient invoicing system. Users of the first invoicing system, over time, accumulate frustration with the MSP and/or the invoicing system itself eventually leading to disengagement. In this example, an MSP who engages a small dental practice using the first invoicing system may receive a notification in respect of attrition risk. “Dental Practices of <10 employees using SOFTWARE 1 are at elevated disengagement risk; based on current support ticket volume and daily average use of SOFTWARE 1 by 3 licensees, COMPANY is predicted to disengage in 90 days. Suggest switch to SOFTWARE 2 as intervention.” In response, the MSP may offer to COMPANY a low-cost option (and/or promotion) to switch to SOFTWARE 2. This is merely one example; may predictions and intervention suggestions can be surfaced in a graphical user interface or notification interface to an agent of an MSP as described herein.

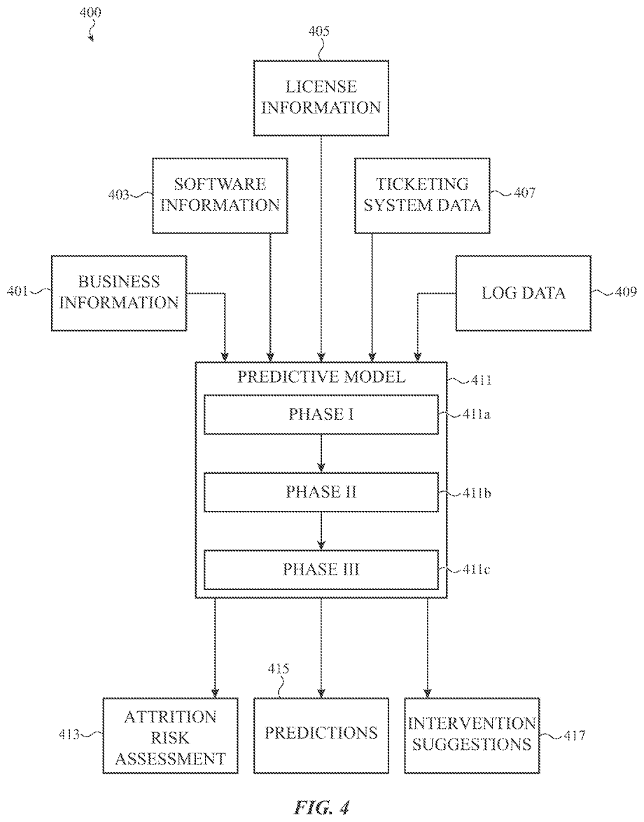

FIG. 4 depicts a diagram depicting a flowchart of training a predictive model 411 to predict third-party software licensee attrition and/or MSP organization client/customer attrition of MSPs or to provide recommendations to MSPs.

The predictive model 411 receives one or more information and data from a third-party database (not shown) or from the access management system described above. The one or more information may include business information 401, software information 403, and license information 405. The data may also include ticketing system data 407 and log data 409.

The business information 401 may include job positions of users of the access management system in a business, business categories, business types, business sizes, business revenues, and business locations. The job positions of users of the access management system in a business may include managers, engineers, technicians, or secretaries if the business is an engineering company. The job positions of users of the access management system in a business may include managers, cashiers, food preparers, or janitors if the business is a restaurant. The business categories may include retail business category, construction business category, investing category, finance category, restaurant category, agriculture category, non-profit category, advertising category, entertainment category, airline category, convenience store category, personal care category, bank category, consultant category, food industry, or the like.

The business types may include sole proprietorship, limited liability company, general partnerships, limited partnerships, limited liability partnerships, C corporation, S corporation, and non-profit corporation. The business size may include small business, medium-sized business, and large enterprise. The business revenue may include historical data of the monthly or yearly revenue of a company. The business locations are the locations where the business is operating or where the headquarter of the business is. The business locations may be categorized by cities, counties, states, provinces, countries, continents, and hemispheres.

The business information 401 may be used as input to the predictive model 411. The predictive model 411 may learn that the users of the access management system in different businesses may have different issues when they use the access management system. For example, an employee in a family restaurant may use a bookkeeping system for their inventories more than a travel agency. The predictive model 411 may predict that the employee in the family restaurant may ask more questions about the bookkeeping system than the employee in the travel agency.

The software information 403 may include software types, software versions, software price, and software features. The software types may include word processing software, business software, finance software, accounting software, computer programing software, database, design software tools, project management software, simulation software, open-source software, utility software, application programming software, graphics software, or the like. The software versions may be version numbers of the software. Software price may be the purchase price of the license of the software. Software features may include performance, portability, or functionality of the software.

The software information 403 may be used as input to extend or supplement a training dataset that in turn can be leveraged to train the predictive model 411. The predictive model 411 may learn that the users of the access management system may have different issues when they use different software. For example, a user in a company using an older version of a word processing software may encounter more compatibility issues than a user in a company with an updated version of the software. The predictive model 411 may predict that the user using the older version of the word processing software may request more technical support and the user may not be satisfied with the software. Therefore, the access management system may notify the MSP that this user may have a higher chance that they will discontinue the license of the current version of the software, but the user may be willing to pay for an updated version of the software in the near future.

In some examples, the software information 403 such as the software features may be used to train the predictive model 411, so the predictive model 411 may provide a more accurate prediction to the MSP. For example, if the predictive model 411 learns that software A has a better performance than software B, the predictive model 411 may predict that the users of the software A may be willing to continue their subscription with software A instead of software B. The predictive model 411 may inform the MSP that users of the software A may generate more revenue for the MSP than users of the software B. In some examples, the predictive model 411 may recommend the MSP to provide some incentives to users of the software B to switch to software A because it may generate more revenue for the MSP if their users use software A more than software B.

The license information 405 may include license types, license versions, license length, and license price. The license types may include free licenses, open-source licenses, proprietary licenses, public domain licenses, and private licenses. The license versions may be version numbers of the license. License length may be the length that the license lasts. License price may be the purchase price of a current version of the license.

The license information 405 may be used as input to extend or supplement a training dataset that in turn can be leveraged to train the predictive model 411. The predictive model 411 may learn that the users of the access management system may have different issues when they own different licenses. For example, a user with a computer engineering background may use software with open-source licenses more often than a user without a computer engineering background. When a user with the computer engineering background uses the software with the open-source license, the predictive model 411 may recommend the MSP to provide more advertisements to the user, so the user may understand the difference between the software with the open-source license and the software with a paid license. The user may switch to the software with the paid license because it saves the user efforts and time to use the software if it provides more functionality than the software with the open source license.

The license information 405 such as the license length may be used as input to extend or supplement a training dataset that in turn can be leveraged to train the predictive model 411. For example, the predictive model 411 may inform the MSP that some users' licenses may expire in a week, and the MSP may understand that the users may have a higher chance to try other software because their licenses expire soon. The MSP may recommend the users with other software that may help the users.

The ticketing system data 407 may include tickets from users of the client devices described above in FIGS. 1-3. In some examples, the ticketing system data 407 may include tickets from users of the MSP regarding the interface of the MSP. The tickets from users of the client devices may include ticket contents, ticket types, ticket frequency (e.g., a number of tickets over a time period, severity of the tickets under a daily rate, a weekly rate, a monthly rate, or quarterly rate), ticket duration, user profiles of the tickets, or the like.

The ticketing system data 407 may be used as input to extend or supplement a training dataset that in turn can be leveraged to train the predictive model 411. The predictive model 411 may learn that the tickets from the client devices may be an indication of various problems of the access management system. For example, if the tickets are from the same user in one week but no other tickets from other users in the same week, the predictive model 411 may learn that the user may not be familiar with the computer and the predictive model 411 may ignore the tickets from this user for this week.

In some examples, if the tickets are from different users in the last three days, and the tickets are related to a same problem of the user interface of one of the software, the predictive model 411 may inform the MSP that this software may have some issues, and the MSP may need to notify the software vendor for the issues that the users report in their tickets. In some examples, the predictive model 411 may inform the MSP that they may see more tickets with similar issues in the next few days before the software vendor solves the problem. The predictive model 411 may recommend the MSP to temporarily suspend the license before the problem solves and provide the users refund of the license if the cost of technical support for these tickets may be higher than issuing the refund of the license to the users.

In some examples, the predictive model 411 may combine the ticketing system data 407 with the business information 401 to better predict the risk and revenue of the MSP. For example, an accountant in a large company may submit more tickets regarding the problems of accounting software than an accountant in a small company because the account in the large company has to handle more complex accounting data than the accountant in the small company. The predictive model 411 may use the business information 401 to know the sizes of the large company and the small company.

The predictive model 411 may divide the number of the tickets from each of these two companies by the number of the employees in each of these two companies to see if the number of tickets per employee is the same or not. If one of the companies has a higher number of tickets per employee than the other, the predictive model 411 may understand that the company with the higher number of tickets per employee may actually have issues when using the software than the other company. The predictive model 411 may inform the MSP to instruct the company with issues to update their software or switch to another with a higher performance so their employees may have less issues with the new software. The predictive model 411 may also predict that the tickets in the company may increase when the company has more employees than before.

The log data 409 may include license provisioning and/or use information from the client devices in the user devices described in FIGS. 1-3. The log data 409 may also include reports, invoices, or other informational content generated from the access management system 106 as discussed above. The log data 409 may be used as input to extend or supplement a training dataset that in turn can be leveraged to train the predictive model 411. For example, the predictive model 411 may learn from the license provisioning and/or use information that users in a company A use software A more often than software B. The predictive model 411 may inform the MSP to recommend software A to the users from the company A instead of software B because users from the company A may dislike the software B if they buy the license of the software B.

In some examples, the log data 409 includes information about one or more software usage information from users of the client devices. The predictive model 411 may be trained to learn the difference of these software usages among users of the client devices from different companies. The predictive model 411 may inform the MSP that the users in a first company may use simulation software more than users in a second company. The predictive model 411 may recommend to the MSP that it is likely that the first company may continue the subscription of the simulation software. The predictive model 411 may suggest the MSP to provide more simulation software options for the first company.

The predictive model 411 receives the business information 401, software information 403, license information 405, ticketing system data 407, and log data 409 as input, and the predictive model 411 is trained by the information and data 401, 403, 405, 407, and 409.

The predictive model 411 includes three phases. Phase I 411a includes identifying features from business information affecting attrition risk exposure of the MSP, identifying features from software information affecting attrition risk exposure of the MSP, identifying features from license information affecting attrition risk exposure of the MSP, identifying features from ticketing system data affecting attrition risk exposure of the MSP, and identifying features from log data affecting attrition risk exposure of the MSP. In some examples, the Phase I 411a may also include identifying one or more data and information affecting third-party software licensee attrition and/or MSP organization client/customer attrition of the MSP.

For example, a user of the client device in FIGS. 1-3 is an engineer, and the user submits five tickets in one hour regarding one of the design software tools that was updated recently. The predictive model 411 may identify the software version from the software information 403 to understand which software version that the user of the client devices has in phase I 411a. The predictive model 411 may identify which company the user works for from the business information 401 in phase 1 411a. After identifying this information in phase I 411a, the identified data or information is sent to phase II 411b for further processing.

Phase II 411b in the predictive model 411 includes pre-processing data or information, data treatment, combining one or more data or information, altering data or information based on use case, and removing data or information impacted by rare events. The data or information may further propagate to phase III 411c for processing. Phase III 411c may include selecting information or data, modelling, identifying a best model, and generating predictions.

After the training of the data and information in the predictive model 411, the predictive model provides revenue predictions 413, risk predictions 415, and recommendations 417. The revenue predictions 413 may be the predictions of the revenue for MSPs if the client devices discussed above continue to use the service from MSPs. The risk predictions 415 may be the predictions of the risk for MSPs if the client devices decide not to continue using a software tool provided by the MSP, or the client devices decide not to continue the service from the MSP. The recommendations 417 may be the recommendation from the predictive model 411 to MSPs. For example, the predictive model 411 may recommend that MSPs provide some incentives to the client devices, so they may continue the service with MSPs.

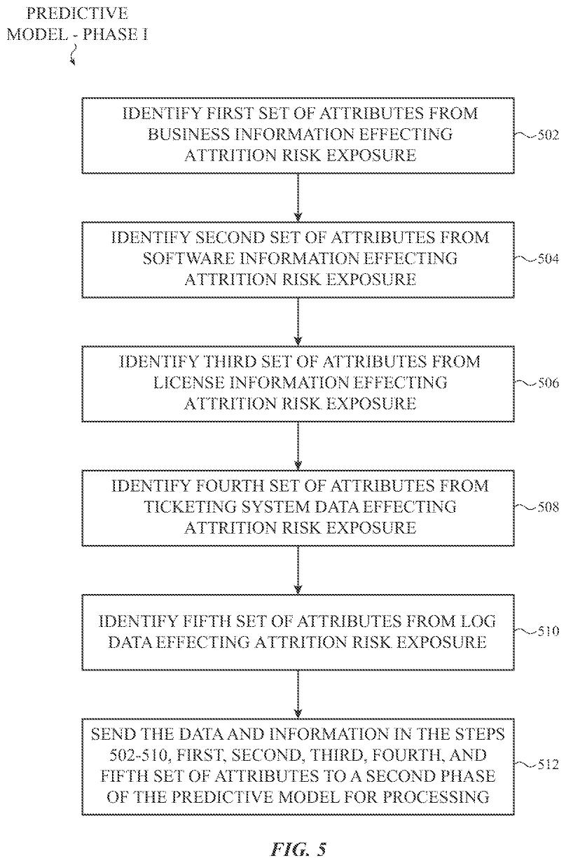

FIG. 5 depicts a diagram depicting a flowchart of phase I in a predictive model 411 to identify attributes affecting third-party software licensee attrition and/or MSP organization client/customer attrition of MSPs.

At operation 502, a first set of attributes from business information affecting third-party software licensee attrition and/or MSP organization client/customer attrition of a MSP are identified. The first set of attributes may include job position attribute, business category attribute, business type attribute, business size attribute, business revenue attribute, and business location attribute. At operation 504, a second set of attributes from software information affecting third-party software licensee attrition and/or MSP organization client/customer attrition of the MSP are identified. The second set of attributes may include software type attribute, software version attribute, software price attribute, and software feature attribute. At operation 506, a third set of attributes from license information affecting third-party software licensee attrition and/or MSP organization client/customer attrition of the MSP are identified. The third set of attributes may include license type attribute, license version attribute, license length attribute, and license price attribute. At operation 508, a fourth set of attributes from ticketing system data affecting third-party software licensee attrition and/or MSP organization client/customer attrition of the MSP are identified. The fourth set of attributes may include ticket content attribute, ticket frequency attribute, ticket duration attribute, and ticket user profile attribute.

At operation 510, a fifth set of attributes from log data affecting third-party software licensee attrition and/or MSP organization client/customer attrition of the MSP are identified. The fifth set of attributes may include license provisioning and/or use attribute and software usage attribute. The license provisioning and/or use attribute may further include one or more attributes for information about an MSP requesting provisioning of the license, information about a licensee for the license, information about the third-party, including information about the third-party service and/or information about the third-party software tool, or any other information. At operation 512, the data and information in the steps 502-510, the first, second, third, fourth, and fifth set of attributes are sent to a second phase of the predictive model for processing.

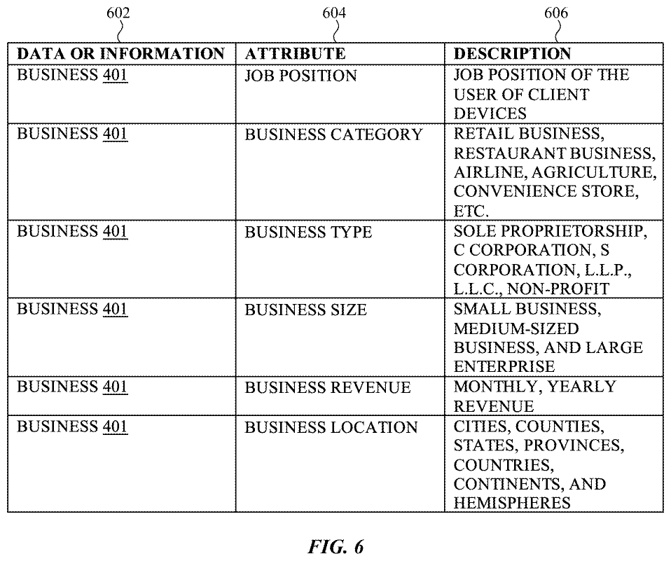

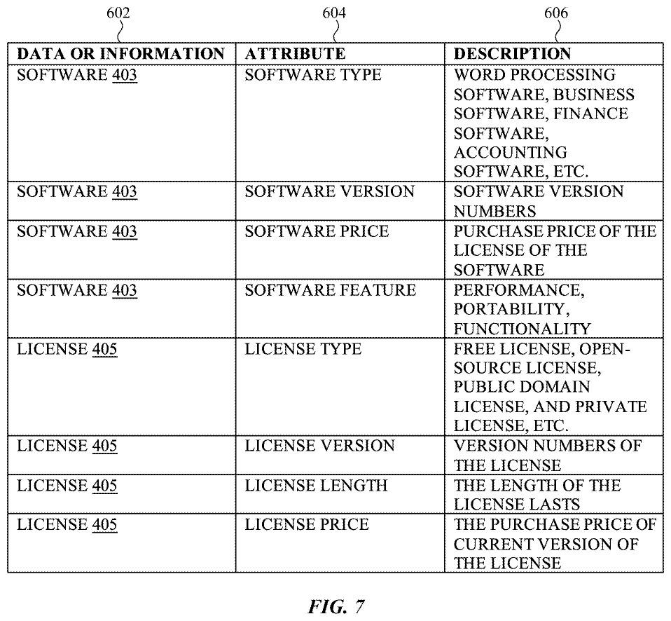

FIGS. 6-8 depict a table of identified attributes 604 which affect third-party software licensee attrition and/or MSP organization client/customer attrition of MSPs in the predictive model 411. The attributes are identified in the phase I in the predictive model 411 as discussed above in FIG. 5. In the table of FIGS. 6-8, columns include data or information 602, attributes 604, and description 606. The data or information 602 includes the data or information 401, 403, 405, 407, and 409 as discussed above in FIG. 4. The description 606 describes the details of the identified attributes 604. After identifying these attributes 604, the attributes are sent to phase II 411b of the predictive model 411 for processing.

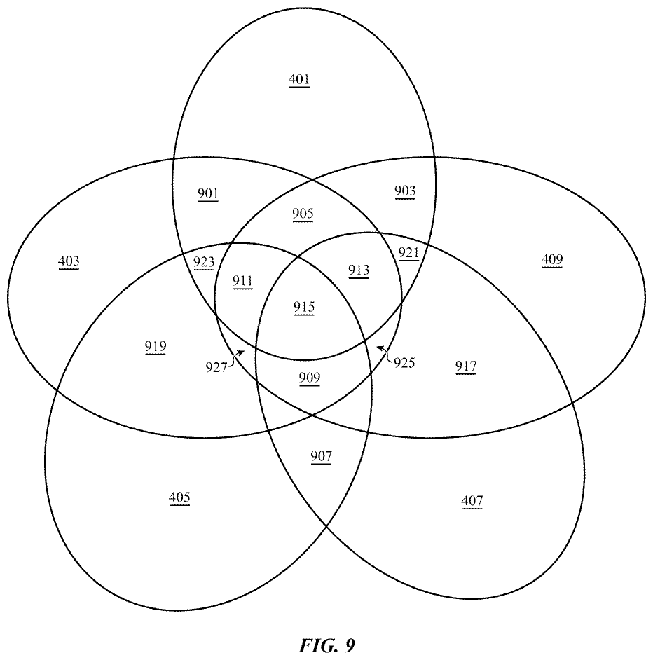

FIG. 9 depicts a diagram of identified attributes affecting third-party software licensee attrition and/or MSP organization client/customer attrition of MSPs in the phase I of a predictive model 411. The data and information 402, 403, 405, 407, and 409 are discussed above in FIG. 4. Each data or information has at least one overlapping area with another data or information. The overlapping areas represent that the data or information has at least two identified attributes 604 in the predictive model 411. The overlapping areas include 901, 903, 905, 907, 909, 911, 913. 915, 917. 919, 921, 923, 925, and 927. For example, an employee in an engineering company submits ten tickets in a day to a ticketing system about a design software tool that was just updated. This information is sent to the predictive model 411 for identification in phase I.

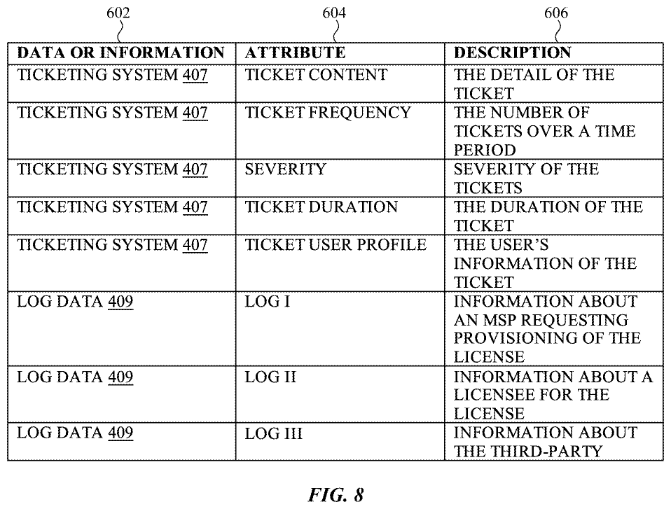

The predictive model 411 may identify that this information has three attributes because this information may need the information from the business information 401, ticketing system data 407, and log data 409. The predictive model 411 may identify this information to learn that the employee is in an engineering company under the business category attribute, and the size of the company may be a large enterprise under the business size attribute in FIG. 8. The predictive model 411 may identify this information to learn that the employee submits ten tickets in a day under the ticket frequency attribute in FIG. 8. The predictive model 411 may identify this information to learn that the software provisioning information under the log I attribute in FIG. 8.

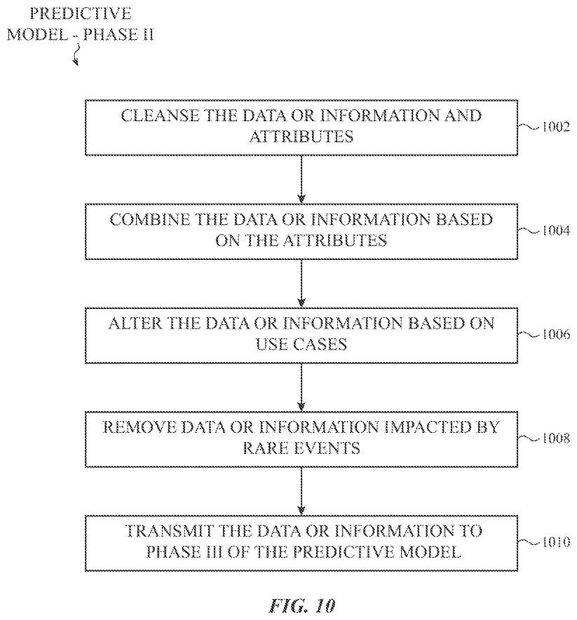

FIG. 10 depicts a diagram depicting a flowchart of phase II in a predictive model 411 to filter the data or information.

At operation 1002, the data and information 401, 403, 405, 407, and 409 and attributes in FIGS. 6-8 are cleansed. Data cleansing is crucial because the data cleansing enhances the quality of the data and the information and boosts overall productivity. If there is a rare event that impacts historical data and information that is in the prediction process, the data and the information may stay in a normal range based on the historical pattern. The rare event in the historical data and information may interfere with the predictive model and the predictions from the prediction process may not be accurate.

At operation 1004, the data and information are combined based on the attributes 604. During the training of the predictive model 411, the data and information are combined based on the identified attributes 604 in phase I. The data and information that are related can be combined. For example, first information is about an engineer using a design software tool. Second information is about another engineer using another design software tool. These two information or data can be combined because these two information are related to the business category attribute and job position attribute.

At operation 1006, the data and information can be altered based on use cases. For example, if the a use case shows that users usually have technical problems between 9 am and 5 pm on weekdays, then the ticket frequency can be altered from weekly to weekdays only.

At operation 1008, the data and information can be removed if the data or information is impacted by rare events. For example, if a software tool is scheduled to be on maintenance between 10 pm and 2 am on Tuesday, the tickets about the software tool between 10 pm and 2 am on Tuesday can be removed because those tickets may not reflect the actual problems of the software tool. At operation 1010, the data and information can be sent to phase III of the predictive model 411 for further processing.

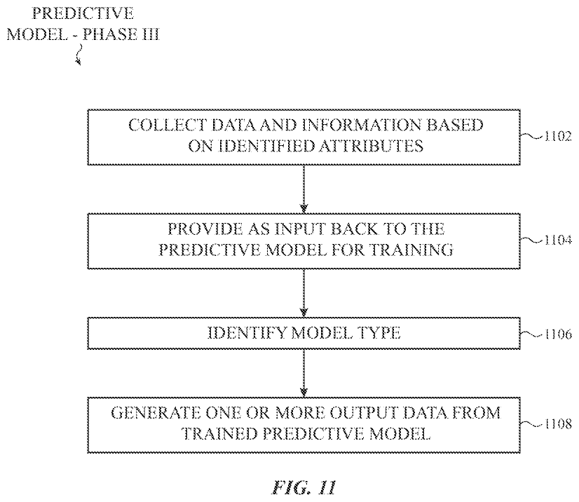

FIG. 11 depicts a diagram depicting a flowchart of phase III in a predictive model 411 to generate one or more output data from the prediction model 411.

Phase III 411c may include selecting information or data, modelling, identifying a best model, and generating predictions. At operation 1102, the data and information may be selected based on identified attributes. For example, for a series of tickets submitted by a cashier in a restaurant regarding the errors of an accounting system may be selected for training in the predictive model 411 based on business location attribute, business category attribute, and job position attribute. At operation 1104, the selected data or information may be sent back to the predictive model for further training because the predictions may be more accurate based on these selected data or information. At operation 1106, a best model based on one or more identified attributes for the data or information may be identified. At operation 1108, the predictive model generates one or more output data based on the best model. The output data may include the revenue predictions 413, risk predictions 415, and recommendations 417.

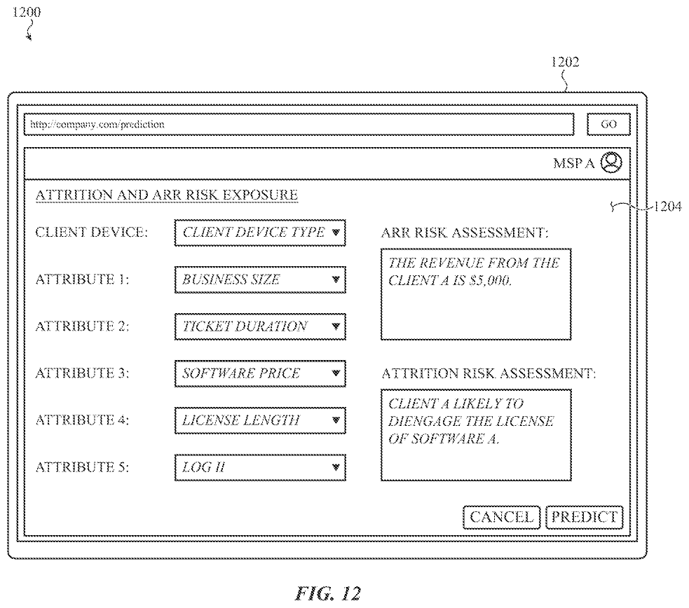

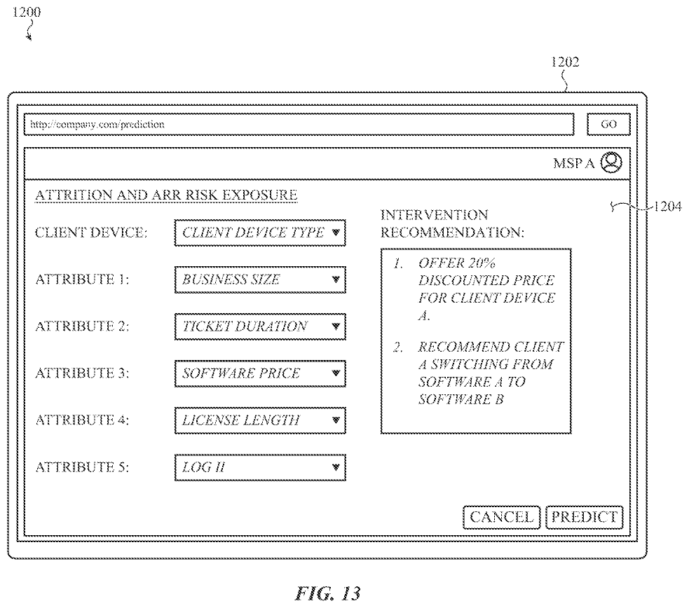

FIGS. 12 and 13 depict a user of a MSP executing an instance of a MSP application rendering a graphical user interface of an access management system such as described herein.

The graphical user interface of the MSP device includes a display 1202 that can be operated by an instance of software initiated by cooperation of a processor and memory (not shown). The instance of software may be referred to as a frontend application, and may cause to be rendered on the display a graphical user interface 1204. The graphical user interface 1204 can include a content view area in which content associated with the frontend application can be rendered.

The frontend application is configured to allow a user to select client device and attributes for the predictive model to predict third-party software licensee attrition and/or MSP organization client/customer attrition of the MSP. As shown, fields for selecting a client device, attributes 1, 2, 3, 4, and 5 are provided. Upon providing the necessary information into the fields, a user can predict the third-party software licensee attrition and/or MSP organization client/customer attrition using a “predict” button.

When the “predict” button is pressed, the frontend application may communicate with a backend access management service to begin the process described above wherein the predictive model is trained, and the predictive model provides revenue, risk, and recommendation to the user as shown in FIGS. 12 and 13.

These foregoing embodiments depicted in FIGS. 1-13 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., drivers licenses, passports, government identification cards or credentials, and so on);protected health information (e.g., medical records, dental records, and so on); financial, banking, credit, or debt information; third-party service account information (e.g., usernames, passwords, social medial handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

What is claimed is:

1. A server system comprising:
a memory resource; and
a processing resource operably intercoupled with the memory resource and configured to instantiate an instance of software configured to:
obtain license information about a license to a third-party software tool from a third-party system;
obtain license provisioning and/or use information about a request to provision a license to the third-party software tool;
provide the license information and the license provisioning and/or use information as input to a predictive model, the predictive model being trained using training data comprising:
previous license information about the license to the third-party software tool;
previous license provisioning and/or use information about the request to provision the license to the third-party software tool; and
additional information about the license; and
receive as output from the predictive model an attrition risk assessment.

2. The server system of claim 1, wherein the license information includes license usage information describing usage of the license to the third-party software tool.

3. The server system of claim 1, wherein the license information includes pricing information related to the license.

4. The server system of claim 1, wherein the license information includes information about an managed service provider that requesting provisioning of the license.

5. The server system of claim 1, wherein the license provisioning and/or use information includes information about a provisioning of the license being succeeded and the third-party software tool being ready to use.

6. The server system of claim 5, wherein the license provisioning and/or use information include information about the provisioning of the license having failed.

7. The server system of claim 1, wherein the additional information includes information collected when operating the system.

8. The server system of claim 7, wherein the additional information includes information about usage of the third-party software tool in the third-party system.

9. The server system of claim 7, wherein the additional information includes information about a subscription record of the license of the third-party software tool.

10. The server system of claim 7, wherein the additional information includes information about a time period using the third-party software tool in the third-party system.

11. The server system of claim 7, wherein the additional information includes information about users using one or more third-party software tools in the third-party system.

12. The server system of claim 1, wherein the attrition risk assessment comprises a numerical value.

13. The server system of claim 1, wherein the predicted risk includes a risk score about users unsubscribing the third-party software tool in the third-party system.

14. A server system comprising:
a memory resource; and
a processing resource operably intercoupled with the memory resource and configured to instantiate an instance of software configured to:
obtain license information about a license to a third-party software tool from a third-party system;
obtain license provisioning and/or use information about a request to provision a license to the third-party software tool;
provide the license information and the license provisioning and/or use information as input to a predictive model, the predictive model being trained using training data comprising:
previous license information about the license to the third-party software tool;
previous license provisioning and/or use information about the request to provision the license to the third-party software tool;
a user history of using the third-party software tool;
a number of tickets about errors during operation of the third-party software tool; and
receive as output from the predictive model an attrition risk assessment.

15. The server system of claim 14, wherein the license information includes license usage information describing usage of the license to the third-party software tool.

16. The server system of claim 14, wherein the license information includes pricing information related to the license.

17. The server system of claim 14, wherein the license provisioning and/or use information includes information about a provisioning of the license being succeeded and the third-party software tool being ready to use.

18. The server system of claim 14, wherein the license provisioning and/or use information includes information about the provisioning of the license having failed.

19. The server system of claim 14, wherein the user history includes a number of times of the third-party software tool accessed by one or more users over a period of time.

20. The server system of claim 14, wherein the errors during operation of the third-party software tool includes failures when users attempt to access the third-party software tool, and failures when users lose access during the operation of the third-party software tool.
